(19) United States
(12) Patent Application Publication
(10) Pub. No.: US 2022/0026737 A1
(43) Pub. Date: Jan. 27, 2022

(54) RETAINING MECHANISM FOR EYEWEAR

(71) Applicant: Jacquelin A. Samuels, Plano, TX (US)

(72) Inventor: Jacquelin A. Samuels, Plano, TX (US)

(21) Appl. No.: 17/296,365

(22) PCT Filed: Jan. 24, 2020
(86) PCT No.: PCT/US20/15116

§ 371 Date: May 24, 2021

Related U.S. Application Data
(60) Provisional application No. 62/771,061, filed on Nov. 24, 2018.

(51) Int. Cl. G02C 5/14

(52) U.S. Cl. CPC G02C 5/14

(57) ABSTRACT

An eyeglass frame (10) having hinged temple arms (20, 26) and a clip (300) associated with at least one of the temple arms to enable the eyeglass frame to be clipped to a layer of clothing between the clip and the at least one arm without slipping. A soft, resilient insert (304) is inserted in the sleeve for slipping over one of the temple arms to thereby resiliently hug the one temple arm (20, 26) while permitting the eyewear to be clipped to an article of clothing.

### CROSS-REFERENCE TO RELATED APPLICATIONS

This application claims the benefit of U.S. Provisional Application No. 62/771,061 filed on Nov. 24, 2018, the disclosure of which is hereby incorporated by reference.

### BACKGROUND OF THE INVENTION

Almost all persons have or will at some time or another use some form of eyewear, whether it be prescription lenses, sunglasses, protective lenses for debris, and so on. With the popularity of digital content and bright computer monitors, smart phone and smart pad screens, and so on, more and more users have become increasingly aware of the potential of UV damage to the eyes, and accordingly new markets have opened up for UV-protective eyewear particularly for use within the range of harmful frequencies to the human eye. Some use eyewear to hide tired or baggy eyes, while others for the enhanced aesthetic appearance they hope to achieve. No matter what the reason or the particular eyewear used, losing such devices has become an ever-increasing problem. Many who are middle-aged and beyond have become accustomed to leaving reading glasses in every room of the home, at work, in the vehicle, and so on, so that the necessity and burden of trying to remember where the eyewear might have been placed, as well as the care needed to ensure safety of the eyewear, it has become an expensive necessity indeed.

When eyewear is removed from a user's face, the glasses are placed in a case and carried around. However, this is inefficient because of the necessity for having the case present even at times when the glasses are being worn and the difficulties of carrying around both the case and the glasses.

When removing eyeglasses from a user's face, they are typically folded in a compact closed position with the temples crossing each other and resting against the back of the frame front portion of the eyeglasses. They are then typically stored in a shirt or pants pocket, in a handbag, an eyeglass case, or left on a desk, counter or other surface, placed in a drawer, on a night stand, or when driving, sunglasses, prescription glasses for long distance viewing, or reading glasses, for example, may be left in the glove compartment, in a side pocket of the car door or in a central console, and so on. Eyewear is also often removed during physical activities such as exercising, swimming, participating in contact sports, and so on, and left in a locker, a gym bag, within the street shoes of the user, and so on, as well as in a myriad of other places. For activities that require eye protection, eyewear has been introduced that is more stylish or fashionable than the large, unwieldy goggles of yesteryear. Such protective eyewear is also typically stored in a location where it can be damaged, lost, or irretrievable. For whatever reason, no matter where the eyewear is placed, and no matter what the eyewear may be used for, all too often it becomes lost, broken, or damaged to a point where it cannot be comfortably supported on a face for enhancing and/or protecting the eyes of a user. Although the shirt pocket has been a convenient place for storing eyewear when not in use, the eyewear can often fall out during walking bending, or leaning over, leading to scratched or broken lenses, frames, and temples. Often when the eyeglasses fall, the unsolicited but often response all too often is to step on them, causing irreparable damage. Accordingly, the solution has been to purchase multiple pairs of eyeglasses and leave them in places frequented by the user in the home, car, or at work for example.

It would therefore be desirous to provide a simple, straight forward solution that would reduce or eliminate parallax reading errors while avoiding high development and manufacturing costs associated with redesigning the gauge head, fuel sending unit and/or tank.

### SUMMARY OF THE INVENTION

In accordance with one aspect of the invention, an eyeglass frame having hinged temple arms and a clip associated with at least one of the temple arms to enable the eyeglass frame to be clipped to a layer of clothing between the clip and the at least one arm without slipping. A soft, resilient insert is inserted in the sleeve for slipping over one of the temple arms to thereby resiliently hug the one temple arm while permitting the eyewear to be clipped to an article of clothing.

Other aspects, objects and advantages of the invention will become apparent upon further study of the following description in conjunction with the attached drawings.

### BRIEF DESCRIPTION OF THE DRAWINGS

The following detailed description of the preferred embodiments of the present invention will be best understood when considered in conjunction with the accompanying drawings, wherein like designations denote like elements throughout the drawings, and wherein:

FIG. 1 is a general front perspective view of eyewear having a retaining frame with a retaining member connected to inner surfaces of the right and left temples in accordance with the invention and illustrating an exemplary implementation of the invention with the eyewear clipped to the pocket of a shirt or pants for retaining and carrying the eyewear when not in use;

FIG. 2 is a general front perspective view of the retaining eyewear having a retaining member connected to inner surfaces of the right and left temples in accordance with a further exemplary embodiment of the invention and illustrating a further exemplary implementation of the invention with the eyewear clipped to the pocket or strap of a purse for retaining and carrying the eyewear when not in use;

FIG. 3 is an enlarged rear isometric view of a portion of the eyewear with the retaining member of FIG. 1 connected to an inner surface of the left temple in accordance with an exemplary embodiment of the invention;

FIG. 4 is an enlarged front isometric view of a portion of the eyewear with the retaining member connected to an outer surface of the left temple in accordance with a further embodiment of the invention;

FIG. 5 is a top rear isometric view of the retaining member of FIGS. 3 and 4 in accordance with the invention;

FIG. 6 is a bottom front isometric view thereof;

FIG. 7 is an enlarged rear isometric exploded view of a portion of the eyewear with a retaining member in accordance with a further embodiment of the invention being connected to the inner surface of the left temple;

FIG. 8 is a top rear isometric view of the retaining member of FIG. 7 in accordance with the invention;

FIG. 9 is a bottom front isometric view thereof;

FIG. 10 is an enlarged rear isometric view of a portion of the eyewear with a retaining member in accordance with a further embodiment of the invention connected to an inner surface of the left temple and biased in a closed position by a torsion spring;

FIG. 11 is a top plan view of the retaining member of FIG. 10 showing movement of a biased clamping arm between the closed position for clamping material therein and the open position for releasing material therefrom or receiving material therein to selectively release and clamp the eyewear with respect to clothing or other objects or material;

FIG. 12 is an enlarged rear isometric view of a portion of the eyewear with a retaining member in accordance with yet a further embodiment of the invention connected to an inner surface of the left temple with a single clipping device in a closed position;

FIG. 13 is a top plan view of the retaining member of FIG. 12 showing movement of the clamping arm between the closed position for clamping material therein and the open position for releasing material therefrom or receiving material therein to selectively release and clamp the eyewear with respect to clothing or other objects or material;

FIG. 13A is a perspective view of a portion of the retaining member of FIG. 13 in the closed position with material or fabric being clamped in the retaining member to hold the eyewear on the pocket of a T-shirt or other clothing where fabric may not be very thick or stiff;

FIG. 14 is an enlarged rear isometric view of a portion of the eyewear with a retaining member in accordance with another embodiment of the invention connected to an inner surface of the left temple with a double clipping device in a closed position;

FIG. 15 is a top plan view of the retaining member of FIG. 14 showing movement of the clamping arm between the closed position for clamping material therein and the open position for releasing material therefrom, or receiving material therein, to selectively release and clamp the eyewear to clothing or other objects or material;

FIG. 16 is a rear isometric view of the eyewear illustrating a left retaining member in accordance with a further embodiment of the invention that has been slid onto the left temple in an assembled position, with an inner surface of the clamping arm facing the inner surface of the left temple, and a right retaining member similar to the left retaining member positioned for sliding onto the right temple;

FIG. 17 is a cross-sectional view of the left retaining member installed on the left temple as viewed along line 17-17 of FIG. 16;

FIG. 18 is a top rear isometric view of the retaining member of FIG. 16;

FIG. 19 is a bottom front isometric view of the retaining member of FIG. 18;

FIG. 20 is a bottom front isometric view of a slip-on retaining member in accordance with a further embodiment of the invention;

FIG. 21 is an enlarged rear isometric view of a portion of the retaining eyewear with a retaining member in accordance with yet a further embodiment of the invention connected to an inner surface of the left temple having a sinuous clamping arm in a closed position;

FIG. 21 is a top plan view of the retaining eyewear of FIG. 21 showing movement of the sinuous clamping arm between the closed position for clamping material therein and the open position for clamping material therein and releasing material therefrom to selectively secure and release the eyewear with respect to the object or article associated with the material;

FIG. 21 is a front left isometric view of a slip-on retaining member having decorative features for enhancing the look or style of eyewear in accordance with a further embodiment of the invention;

FIG. 22 is a rear left isometric view thereof;

FIG. 23 is a left side elevational view thereof; and

FIG. 24 is a top plan view thereof.

It is noted that the drawings are intended to depict only exemplary embodiments of the invention and therefore should not be considered as limiting the scope thereof. It is further noted that the drawings may not be to scale. The invention will now be described in greater detail with reference to the accompanying drawings.

### DETAILED DESCRIPTION OF THE INVENTION

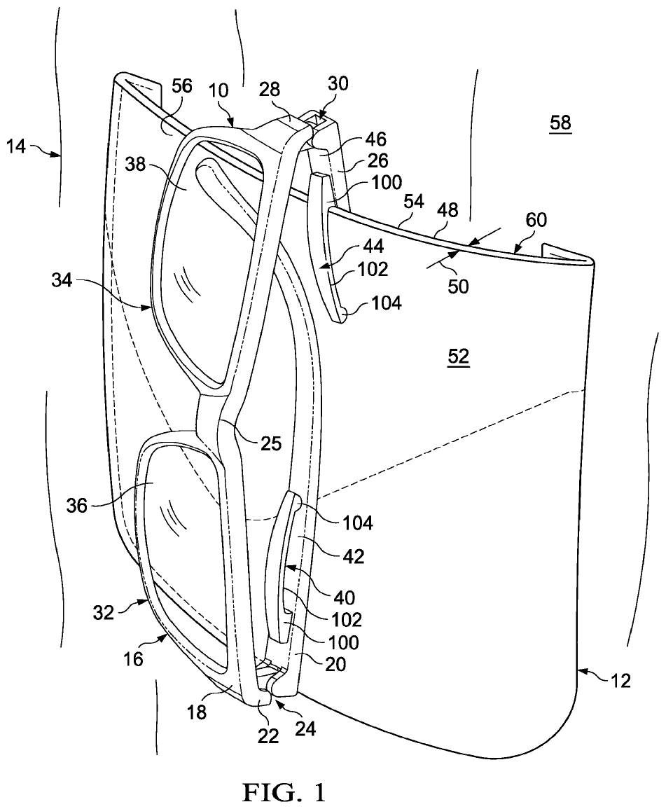

Referring now to the drawings, and to FIG. 1 in particular, retaining eyewear 10, such as a pair of eyeglasses, protective eyewear, sunglasses, prescription lenses, and so on, in accordance with an exemplary embodiment of the invention, is illustrated attached to the pocket 12 of an article of clothing 14, such as a shirt, blouse, pair of pants, and so on, for securing and carrying the retaining eyewear 10 when not in use with a high confidence level that the eyewear will stay clamped on a shirt pocket or the like or wherever it has been placed when not in use.

The retaining eyewear 10 preferably includes a retaining frame 16 having a frame front portion 18 with a bridge 25 supported on a nose of a person in a known manner, with a left temple 20 pivotally connected to a left end 22 of the frame front portion 18 via a left hinge joint 24, and a right temple 26 connected to a right end 28 of the frame front portion 18 via a right hinge joint 30. The frame front portion 18 as shown comprises a full rim having a left lens opening 32 and right lens opening 34 that completely surround and retain a left lens 36 and a right lens 38, respectively. Lens securing means (not shown), such as a lens groove, can be associated with the inner periphery of each frame for holding the left and right lenses in place in a known manner.

A first retaining member 40 is shown connected to an inner surface 42 of the left temple 20. Likewise, a second retaining member 40 is shown connected to an inside surface 46 of the right temple 26. The first and second retaining members 40 are identical in construction, and therefore will be described with the same reference numerals, it being understood that different retaining member embodiments, as disclosed herein, as well as their equivalents, can be connected on the same retaining frame 16 or the like for accommodating different material types and thicknesses as well as different mounting requirements, without departing from the spirit and scope of the invention.

The second retaining member 40, as shown in FIG. 1, is clamped around an outer edge 48 of an outer panel 56 of the pocket 12, which typically includes two or more layers (not shown) of material doubled over for adding thickness 50 to the outer edge 48 of the pocket as measured between the outer surface 52 and inner surface 54 of the outer pocket panel 56. The outer pocket 56 is typically sewn or otherwise attached to a panel 58 of material forming the article of clothing 14 to thereby create an inner pocket space 60 that receives the right temple 26 when the eyewear are clamped to the panel 58 of the pocket 12. Depending on the article of clothing 14, the particular material and weight or thickness of the material used for the clothing, including the pocket 12, the thickness of the panel 56 and thus the outer edge 48 of the panel, can vary. Accordingly, the retaining members 40 and the several embodiments described throughout the specification, are configured and positioned to accommodate varying thicknesses of the edge 48 and the panel 56, as well as different mounting conditions or arrangements, so that the retaining eyewear 10 does not inadvertently slip out of a pocket for example with relatively thin materials.

The provision of first and second retaining members 40 on the inner surface 42 of the left temple 20 and inner surface 46 of the right temple 26 enables the user to insert the pair of retaining glasses with the right temple 26 extending into the inner pocket space 60 and the second retaining member 40 clamped onto the panel 58 of pocket 12 around the outer edge 48 thereof. Likewise, the user can just as easily insert the pair of retaining eyewear 10 with the left temple 20 extending into the inner pocket space 60 with the first retaining member 40 clamped onto the panel 58 of pocket 12 around the outer edge 48 thereof, while the second retaining member can be left without clamping with the left temple 20 folded under the frame front portion 18. In this manner, the retaining eyewear 10 can be quickly and easily clamped onto a pocket panel 58 with one of the temples 20 or 26 inserted into the inner pocket space 60 from either the right end 28 or left end 22 of the frame front portion 18 without the need to stop and rotate the eyewear to the proper position, which would inevitably occur with a single retaining member 40. However, it will be understood that a single retaining member 40 can be used on either the left temple 20 or right temple 26 without departing from the spirit and scope of the invention.

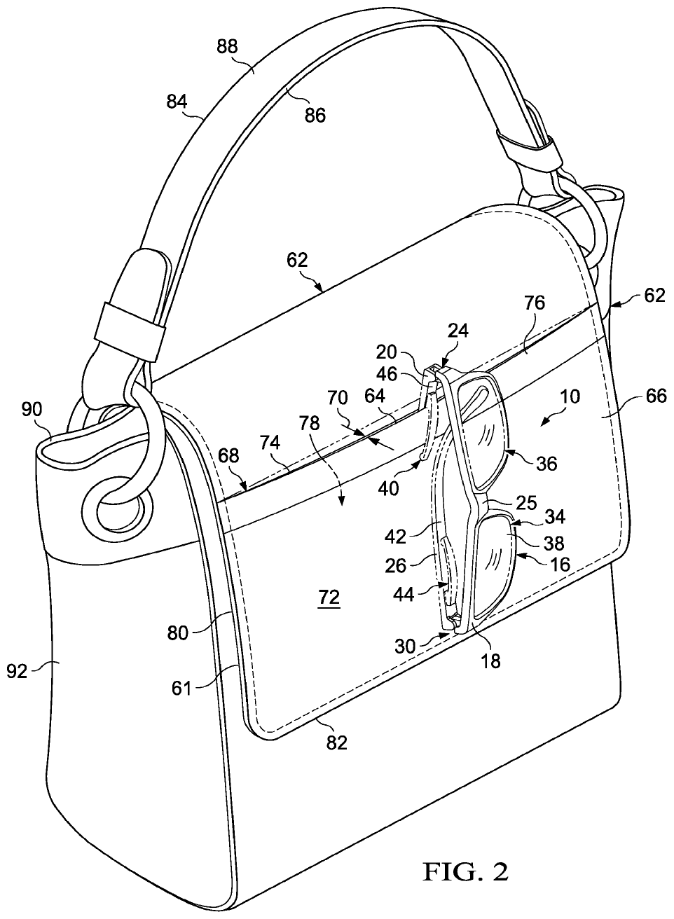

Referring now to FIG. 2, the retaining eyewear 10 in accordance with the invention, can be removably clamped onto one or more objects besides clothing, such as a purse or handbag 62 and various free edges that may be available. The first retaining member 40, as shown in FIG. 2, is clamped around an edge 64 of an outer panel 66 of material that defines a pocket or compartment 68 associated with a flap 61 of the handbag 62. The compartment 68 also typically includes two or more layers (not shown) of material doubled over for adding thickness 70 to the edge 64 of an outer compartment panel 76 that forms the compartment 68 in the flap 61 as measured between the outer surface 72 and inner surface 74 of the outer compartment panel 76. The outer compartment panel 76 is typically sewn, heat-sealed, or otherwise attached to the flap 61 in a known manner to thereby create an inner pocket space 78 that receives the left temple 20 when the eyewear is clamped to the panel 76 of the compartment 68 with the first retaining member engaging the outer surface 72 of the outer compartment panel 76 and the left temple 20 engaging the inner surface 72 thereof so that the material associated with the handbag compartment is clamped between the first retaining member 40 and the left temple 20.

Accordingly, as shown in FIGS. 1 and 2, the provision of retaining members 40 on the left and right temples 20 and 26, respectively, enables the user to insert the eyewear 10 into a pocket or compartment with either the right end 28 or left end 22 of the frame front portion 18 without the need to stop and rotate the eyewear to the correct position when only one retaining member of the invention is used, for example. However, it will be understood that the present invention is not limited to temporarily attaching the pockets or compartments, but can be used to attach the eyewear to other edges, such as the edges 80 or edge 82 associated with the flap 61 of the handbag 62, the edges 84 and 86 associated with a strap 88, the open edge 90 of the handbag body 92, as well as many other locations, such as the front placket or edge of the box plate between buttons or button holes, as well as the cuff, collar, and so on, pants pockets, the outer and/or inner pockets of suit jackets, sport jackets, coats, sweaters, and so on, as well as the free edges of waistbands, skirts, belts, belts, belt loops, and/or other convenient edges associated with undershirts or other underclothing, exercise clothing, uniforms, and so on, including other panels such as sun visors of hats, vehicles, notebooks, notepads, clipboards, and other flexible and stiff panels associated with various products commonly used, where access to the clamped eyewear can be quickly and discreetly obtained and removed for use and quickly returned for retention and storing. The retaining members of the invention thus allow the eyewear to be accessible and within view so the user can respond to the immediate need to wear the eyeglasses, whether for protection against sunlight, UV light from the sun, computer monitors, smart phones, television screens, and other digital or analog devices with displays, and other harmful rays, protection against bright lights in oncoming traffic at night or at the rising of the sun in the early morning when traveling in a direction toward the sunrise, protection against flying debris while working with tools, or in manufacturing environments where safety glasses are required, as well as for reading small print and/or seeing long distances for driving or flying, and so on.

It is therefore contemplated that the various embodiments of the invention as disclosed herein, as well as their equivalents, can be removably secured on a panel of material or the like with a high degree of confidence that the retaining eyewear will stay where it has been clamped. The various embodiments of the invention, as described herein, are designed with unique features to address the various different materials, material thicknesses, edge finishes, and so on, that may exist with respect to clothing, handbags, back-packs, notebooks, and so on, where a convenient edge of flexible, resilient, elastic, or even relatively hard material can be used for removably retaining the eyewear.

Although a full-rim frame front portion 18 is illustrated in FIGS. 1 and 2 for example, it will be understood that the retaining frame 16 can comprise a half-rim frame front with a lower peripheral edge of the right and left lenses being supported by a thin chord or the like in a well-known manner. Likewise, the retaining frame can comprise a rimless frame front (not shown) with only a bridge that joins the left lens 36 and right lens 38 together via threaded fasteners that clamp the bridge to the left and right lenses, with the left and right temples also being secured to the left and right lenses via threaded fasteners. Accordingly, it will be understood that the invention is not limited to the particular full frame front as shown, but can include any frame type or style without departing from the spirit and scope of the invention.

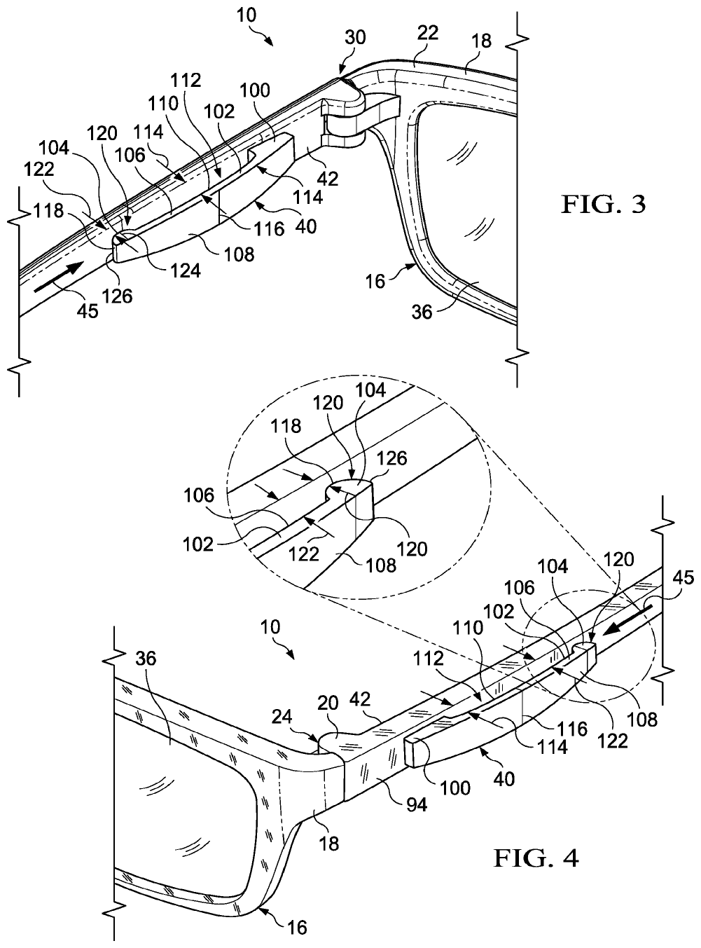

Referring now to FIGS. 3 and 4, the retaining member 40 is shown connected to the inner surface 42 of the left temple 20 as shown in FIG. 3, while the retaining member 40 is shown connected to the outer surface 94 of the left temple 20, as shown in FIG. 4. Although not shown, the retaining member 40 can also or alternatively be connected to the outer surface (not shown) of the right temple 26 (FIG. 1). The position of the retaining member 40 on the outer surface of the left temple 20 and/or right temple 26 can facilitate the insertion of the retaining eyewear 10 into a pocket or the like as described above, since the retaining member is more readily accessible and can be viewed as the user aligns the retaining member 40 with the outer free edge 48 (FIG. 1) of a pocket or the like. With this embodiment, a substantial portion of the retaining eyewear can be inserted into the pocket to provide better protection of the eyewear, while hiding a substantial portion thereof from the view of others.

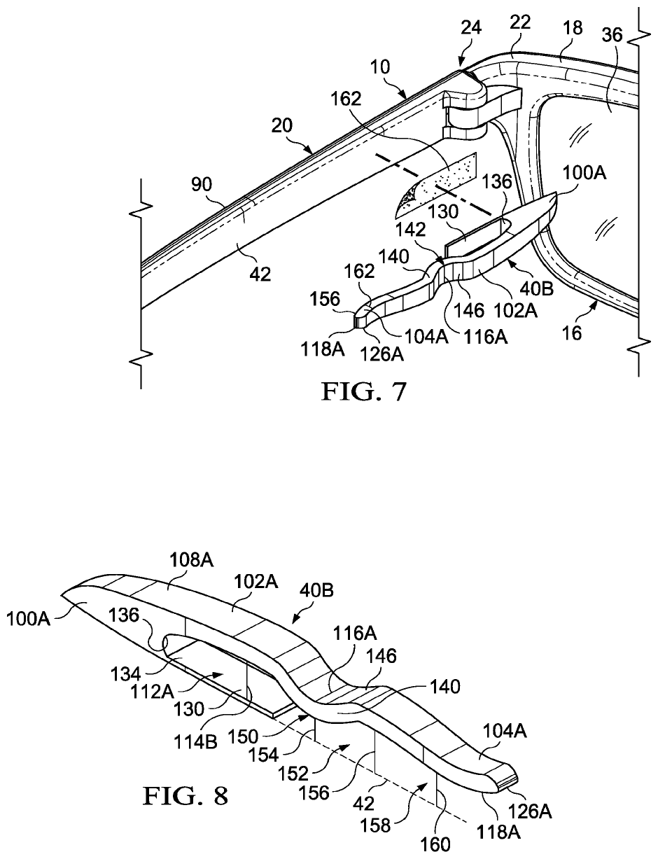

The retaining member 40 can be integrally formed with the left temple 20 and/or right temple 26 during manufacture, or in accordance with a further embodiment of the invention, can be separately formed and connected to the left temple 20 and/or right temple 26 through surface welding, ultrasonic welding, adhesive bonding, hook and loop fasteners, double-sided tape (see FIG. 7), magnets and ferromagnetic materials embedded in the retaining members 40, the left temple 20 and/or right temple 26, threaded fasteners, clamps, cooperating mechanical configurations for snap-fitting the retaining members to the inner and/or outer surfaces of one or both temples, and so on. When the retaining member 40 is provided separately, connecting means such as disclosed above can also be included so that the end user can install the retaining members at any position on the right temple and/or left temple or anywhere on the frame 16 of the eyewear convenient to the user.

The retaining members 40 associated with the left temple 20 and right temple 26 are identical in construction, and therefore only one retaining member 40 will be described, it being understood that the description of one retaining member also applies to the other retaining member, with like elements of each retaining member being represented by like reference numerals.

The retaining member 40 preferably includes a base portion 100, an elongate lever arm 102 connected to the base portion 100 and extending rearwardly therefrom in a cantilevered fashion, and an enlarged clamping jaw portion or bulb 104 located at the outer free end 106 of the lever arm 102. As shown, the cantilevered curved lever arm 102 is generally convex in shape with an outer convex surface 108 and inner convex surface 110 that curve outward with respect to the inner generally flat surface 42 of the left temple 20 when connected thereto, as shown in FIG. 3, to form a first retention gap 112 with a first width 114 that gradually increases until reaching the first crest 116 of the cantilevered curved lever arm 102 and then decreases until reaching the clamping jaw portion 104. The first clamping jaw portion 104 preferably has a semi-circular inner surface 118 that faces the inner surface 42 of the left temple 20 when the base portion 100 is connected thereto, and faces the outer surface 94 when the base portion 100 is connected thereto, to thereby form a second retention gap 120 with a second width 122 that decreases until reaching the second crest 124 of the clamping jaw portion 104, then increases until the outer free end 126 of the first clamping jaw portion 104 is reached.

In use, the edge 48 (FIG. 1) of a pocket, panel, or the like for example, can be easily aligned with and inserted into the second retention gap 120, as shown by arrow 45 in FIGS. 3 and 4 by moving the eyewear towards the edge 48, causing the curved lever arm 102 to flex outwardly from the inner surface 42 (or outer surface 94) against the forces created by the resistance to bending moment by the convex curved shape of the lever arm 102, thereby increasing the second width 114 and first width 114 under greater biasing force from the cantilevered lever arm 102 over a lever arm of equivalent thickness and length but without the convex curve shape. Accordingly, opposing biasing forces act on opposite sides of the panel of material by the inner surface 118 of the clamping jaw portion 104 and the inner surface 42 (or outer surface 94) of the left temple 20, to thereby retain the panel of material within the first and second retention gaps under frictional forces normal to the biasing forces. When the material is flexible, it will tend to gather and bunch up within the first retention gap 112, causing further resistance against the eyewear from inadvertently slipping off of the panel of material, and thereby adding to the retention capacity of the first retaining member 40 in conjunction with the left temple 20. Accordingly, the eyewear can be firmly clamped onto a panel of material for retaining the eyewear thereto while reducing or eliminating undesired or inadvertent slipping of the eyewear from off the panel of material, such as associated with a pocket, handbag, waistband, and so on, as previously described.

The retaining members 40 are preferably constructed of material with sufficient stiffness to hold the panel of material in place, yet having sufficient flexibility to allow insertion of the material through the first retention gap and into the second gap, while resisting removal of the material therefrom below a predetermined pulling force, so that only pulling forces above the predetermined level by the user will enable removal of the eyewear from the pocket or other panel of material. Suitable materials can include, but are not limited to, plastic formulations that exhibit elastic deformation only when materials panels of a maximum thickness are inserted into the second retention gap 120, as well as elastomer formulations, spring steel and other metals with elastic deformation in the predetermined range of maximum panel thickness, composites such as epoxy formulations with carbon or glass fiber strands or sheets, as well as other materials that exhibit elastic deformation within the range of opposing forces created by the retaining member 40 when a panel of material is inserted in the retention gaps.

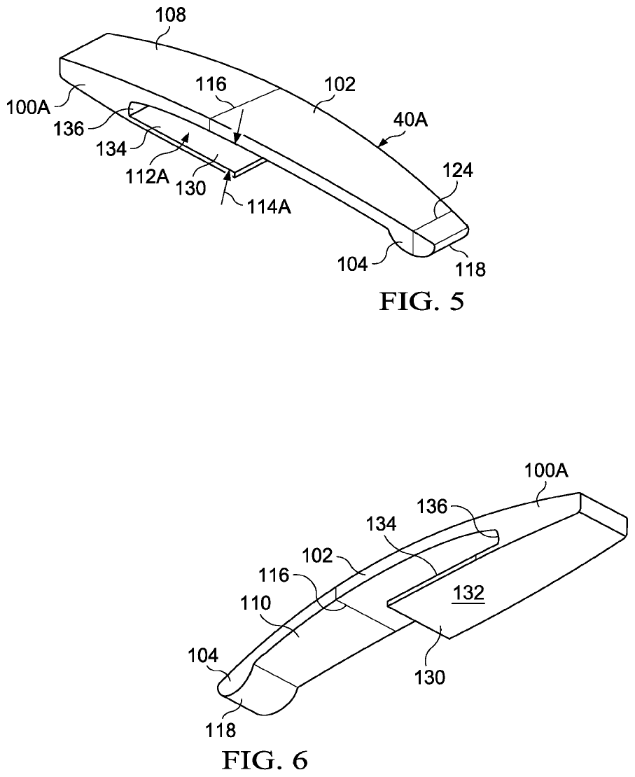

Referring now to FIGS. 5 and 6, a first retaining member 40A for connection to the inner surface 42 and/or outer surface 94 (FIG. 4) of the left temple 20 and/or right temple 26 for connection to the inner surface 46 and/or outer surface of the right temple 26, in accordance with a further embodiment of the invention. The retaining member 40A is identical in construction, and similar to the retaining member 40 previously described, with the exception that the base member 100A includes a mounting platform 130 that extends rearwardly to approximately the first crest 116 of the curved lever arm 102 to create the first retention gap 112A between the inner surface 104 of the lever arm 102 and the inside surface 134 (FIG. 5) of the mounting platform 130 with a first width 114A that gradually increases until reaching the first crest 116 of the curved lever arm 102 and then decreases, in conjunction with the inner or outer surface of one of the temples, when connected thereto, until reaching the clamping jaw portion 104, as previously described with respect to the first retaining member 40. The mounting platform 130 also includes a mounting surface 132 that is spaced from and faced away from the inside surface 134. The mounting surface 132 is advantageous in that: 1) a greater surface area is available for connecting the retaining member 40A to one of the surfaces of the temple, to thereby ensure the retaining member 40A has a greater bonding strength than the retaining member 40 previously described; and 2) by extending the mounting platform rearwardly toward the crest 116, all bending forces, which previously were concentrated at the interface between the surface of the temple and the base member 100 which would tend to separate the retaining member 40 from the left temple 20, for example, are now divided, with a substantial amount of the bending forces concentrated at the junction 136 between the lever arm 102 and the mounting platform 130. With the shift of forces from the interface or connecting means to the junction 136, much less force is now available to pull apart the retaining member 40A from the temple 20. Accordingly, the retaining member 40A is a more stable design and ensures a better connection between the retaining member 40A and the inner surface 42 and/or outer surface 96 of the temple 20 to which the retaining member 40A is mounted, while allowing greater clamping forces on the panel of material, as previously described.

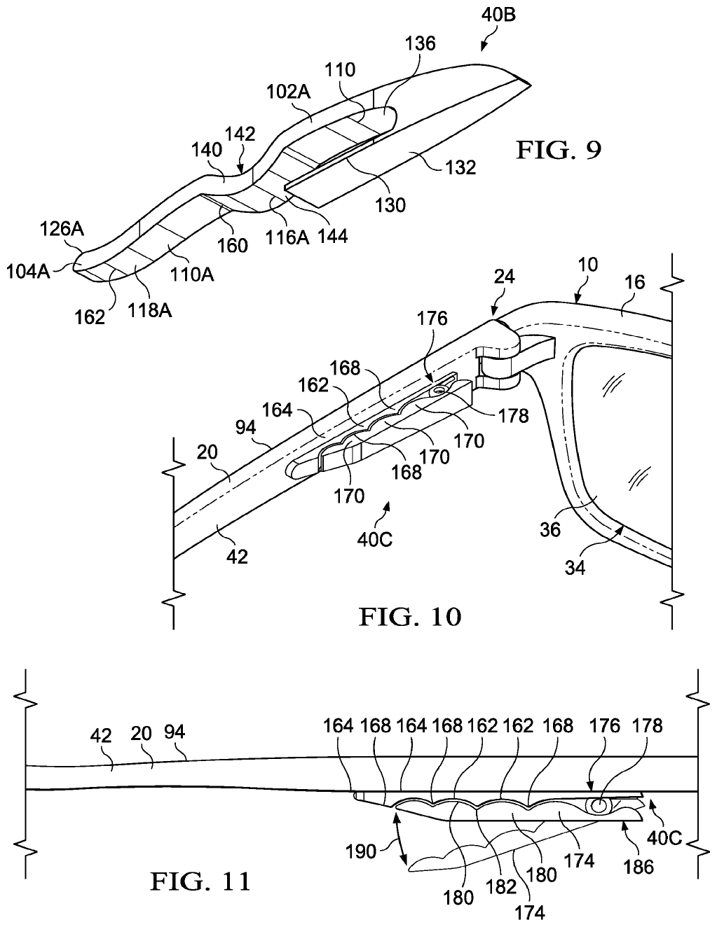

Referring now to FIGS. 7 to 9, a first retaining member 40B for connection to the inner surface 42 and/or outer surface 94 (FIG. 4) of the left temple 20 and/or right temple 26 for connection to the inner surface 46 and/or outer surface of the right temple 26, in accordance with another embodiment of the invention is illustrated. The retaining member 40B are also identical in construction, and similar to the retaining member 40A previously described, with the exception that the cantilevered lever arm 102A has a first convex-shaped curve that extends between the mounting base 100A and the first clamping jaw portion 104A, which is interrupted at its crest 116A by a second concave-shaped curve 140 that is positioned rearwardly of the mounting platform 130 and projects toward the inner surface 42 (FIG. 7) or outer surface 96 of the left temple 20 to thereby form a second clamping jaw portions 142 spaced forwardly of the first clamping jaw portions 108A. The second clamping jaw portions 142 has a second inner convex curved surface 144 and second outer convex curved surface 146 in alignment with the crest 116A, which is similar to the location of the crest 116 of the lever arm 102 in the previous embodiment. The second inner convex curved surface 144 faces the outer surface 96 or inner surface 42 of the left temple 20 when connected thereto, as shown in FIG. 8 in phantom line, to form a first retention gap 112A with a first width 114 that gradually increases from the junction 136 of the lever arm 102A and the base member 100A until reaching the second inner convex curved surface 144 whereupon the first width 114B rapidly decreases until reaching the first crest 116A of the second clamping jaw portions 142 of the curved lever arm 102A to form a second retention gap 150 that has a second width 154 much less than the first width 114B of the first retention gap 112A. A third retention gap 152 has a third width 156 that rapidly increases between the inner surface 110A of the lever arm 102A and the outer surface 96 or inner surface 42 of the left temple 20 when connected thereto, as shown in FIG. 8 in phantom line. The third width 156 of the third retention gap 152 begins to decrease in width at the rear end 160 (FIG. 9) of the lower concave surface 144 until it converges with the crest 162 (FIG. 9) of the first clamping jaw portion 104A. The first clamping jaw portion 104A also has a concave shape with a concave inner surface 118A that faces the inner surface 42 or outer surface 96 of the left temple 20 when the base portion 100 is connected thereto, as shown in FIG. 8, to thereby form a fourth retention gap 158 with a fourth width 160 that increases toward the outer free end 126A of the clamping jaw portion 104A.

With the above-described embodiment of the retaining member 40B, the edge 48 (FIG. 1) of a pocket, panel, or the like for example, can be easily aligned with and inserted into the fourth retention gap 158, as shown by arrow 45 in FIGS. 3 and 4 for example, causing the curved lever arm 102A to flex outwardly from the inner surface 42 (or outer surface 94) against the forces created by the resistance to bending moment by the convex curved shape of the lever arm 102A at the junction 136 between the lever arm 102A and the mounting platform 130 thereby increasing the width 160 of the fourth retention gap 158 under biasing force from the cantilevered lever arm 102A, which also causes the width 154 of the second retention gap 150 to increase under greater biasing force, as the second retention gap 150 is closer to the junction 136 than the first retention gap and therefore subjected to greater resistance against increasing the width 154 of the second retention gap (FIG. 8). In this manner, the second retention gap 150 does not open very wide and the second clamping jaw portion 150 is capable of exerting opposing biasing forces against the panel of material with a greater pressure and frictional forces than the first clamping jaw portion 104A. Accordingly, a double clamping effect can be realized with the second clamping jaw portions 142 clamping with greater force on the panel of material than the first clamping jaw portion 104A (FIG. 8).

Accordingly, opposing biasing forces act on opposite sides of the panel of material by the inner surface 118A of the clamping jaw portion 104A and the inner surface 42 (or outer surface 94) of the left temple 20 that function as first opposing clamping jaws, as well as the greater opposing biasing forces acting on opposite sides of the panel of material by the inner surface 144 of the second clamping jaw portion and the inner surface 42 (outer surface 94) of the left temple 20 that function as second opposing clamping jaws, to thereby retain the panel of material within the first and second retention gaps by the first and second sets of opposing clamping jaws with compression forces normal to the panel of material, as well as retaining the material under frictional forces normal to the biasing forces created by the first and second sets of opposing clamping jaws. When the material is flexible, it will tend to gather and bunch up within the first retention gap 112A and the third retention gap 152, causing further resistance against the eyewear from inadvertently slipping off from the panel of material, and thereby adding to the retention capacity of the first retaining member 40B in conjunction with the left temple 20. Accordingly, the eyewear can be firmly clamped onto a panel of material for retaining the eyewear therewith while reducing or eliminating undesired or inadvertent slipping of the eyewear off the panel of material, such as associated with a pocket, handbag, waistband, and so on, as previously described.

As shown in FIG. 7, the retaining member 40B is shown being mounted to the inner surface 42 of the left temple 20 of the eyewear 10 with an adhesive strip 162 comprising double-sided adhesive tape that is shaped to fit the connecting surface 132A of the base member 100A including the mounting platform 130. In this manner, the end user can position the retaining member 40B, as well as the retaining member 40A or retaining member 40 at any location along any surface of the right temple 26 and/or left temple 20.

Referring now to FIGS. 10 and 11, a retaining member 40C in accordance with a further embodiment of the invention is illustrated. The retaining member 40C can be connected to the inner surface 42 and/or outer surface 94 (FIG. 4) of the left temple 20 and/or right temple 26 for connection to the inner surface 46 and/or outer surface of the right temple. The retaining member 40C includes a base member 162 with a mounting surface 164 connected to one of the surfaces of the left temple and/or right temple 26 (FIG. 4) of the eyewear frame 16 through connecting means as described above. The base member 162 is formed as a first jaw portion 166 with alternating first peaks or teeth 168 and first valleys 170 extending between the teeth 168. The first teeth 168 are preferably pointed, while the valleys 170 are curved.

A second jaw portion 174 is pivotally connected to the first jaw portion 166 via a pivot joint 176 and is biased toward a closed position, as shown in FIGS. 10 and 11 by a torsion spring 178 or other biasing member for holding the jaws closed. The second jaw portion 174 also includes alternating second peaks 180 that are rounded and complementary in shape to the first valleys 170 of the first jaw portion 166, and second valleys 182 that are pointed and complementary in shape to the first teeth 168 so that the first and second jaw portions 168 and 174, respectively, can capture flexible material therebetween when a biasing force is applied by a user to a forward end 184 of the second jaw portion on a side of the pivot joint 176 opposite the second peaks 180 and second valleys 182, as denoted by arrow 186 in FIG. 11, to open the second jaw portion 174 with respect to the first jaw portion 168, as shown by phantom line in FIG. 11 and the double arrow 190 showing opening of the second jaw portion 174 against bias forces of the torsion spring 178 and closing of the second jaw portion 174 automatically when the applied force is removed. In this manner, the retaining eyewear 10 can be quickly and easily aligned with the edge 82 (FIG. 1) of a pocket or the like and the retaining member 40C is then opened, as described, and slid over the panel of material until the edge 82 is located as deep as possible between the first and second jaw portions. The second jaw portion 174 is then released, causing the second jaw portion to automatically rotate to the closed position, thereby entrapping the panel of material therebetween with the first and second peaks and valleys and their complementary shapes ensuring that the retaining eyewear remains firmly attached to the article of clothing or other object, as previously described.

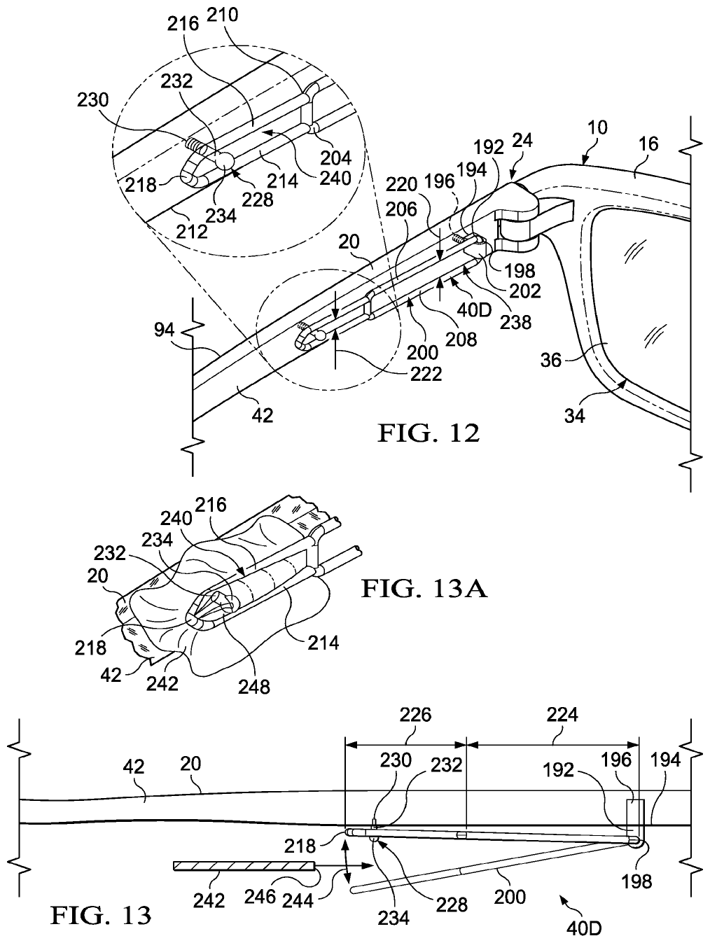

Referring now to FIGS. 12 and 13, a retaining member 40D in accordance with a further embodiment of the invention is illustrated. The retaining member 40D, as in the previous embodiments, can be connected to the inner surface 42 and/or outer surface 94 (FIG. 4) of the left temple 20 and/or right temple 26 for connection to the inner surface 46 and/or outer surface of the right temple. The retaining member 40D includes a base member 192 with an inner surface 194 connected to one of the surfaces of the left temple and/or right temple (FIG. 4) of the eyewear frame 16 through connecting means as described above. Since the base member 192 is relatively small, a metal insert or fastener 196 (shown in hidden line in FIG. 13) can be used for installing the base member 192 onto one of the surfaces of the left temple 20 and/or right temple 26. The base member 192 includes an aperture 198 with an elongate spring clip 200 having a pivot rod 202 (shown in hidden line in FIG. 12) that allows free pivotal movement of the spring clip 200 with respect to the base member 192, and thus with respect to the left temple 20 as shown. The spring clip 200 also has a first wire frame portion 204 formed by the pivot rod 202, first second elongate rods 206 and 208 extending from the pivot rod 202, and a cross-rod 210 extending between the elongate rods 206, 208. A second wire frame portion 212 extends from the first wire frame portion 204 and includes second elongate rods 214 and 216 extending from the cross-rod 210 and terminating with a rear tip portion 218 so that the first and second wire frame portions are enclosed.

As shown in FIG. 12, the first wire frame portion 204 preferably has a first elongate slot 238 with a first width 220 that is greater than a second width 222 of a second elongate slot the second wire frame portion 212. Likewise, a first length 224 (FIG. 13) of the first wire frame portion is longer than a second length (226) of the second wire frame portion. A catch member 228 is connected to the same surface of the same temple as the base member 192 and spaced rearwardly therefrom for receiving and locking the spring clip 200 in the closed position. Since the catch member 228 is relatively small, a metal insert or fastener 230 (shown in hidden line in FIG. 13) can be used for installing the catch member 228 onto one of the surfaces of the left temple 20 and/or right temple 26. It will be understood that other connecting means for connecting the catch member 228 and the base member 192 can be used as previously described. The catch member 228 includes a stem 232 extending from the surface 42 of the temple 20 or the like, and an enlarged, spherically-shaped ball-catch 234 located on an outer free end of the stem 232.

In use, and with additional reference to FIG. 13, the retaining member 40D is initially shown in the closed position, with the first wire frame portion 204 and second wire frame portion 212 close to the inner surface 42 of the left temple 20. In this position, the stem 232 extends through the second elongate slot 240 of the second wire frame portion 212. Since the second width 222 of the second elongate slot 240 of the second wire frame portion 212 is less than the outer diameter or cross-dimension of the ball-catch 234, the second wire frame portion 212 normally cannot slip past the ball-catch and inadvertently open, even when one or more layers of material have been inserted over the ball-catch and through the elongate slot 240 between the rods 214 and 216. In order to open the spring clip 200, the user applies sufficient force to the rear tip portion 218 of the clip 200 in a direction away from the inner surface 42 of the temple 20 for example, to force the rods 214 and 216 around the ball-catch 234, causing the clip 200 to pivot in opposite directions, as represented by arrows 244 in FIG. 13, between the open position 200 (shown in phantom line in FIG. 13) and the closed position. When the clip 200 is in the open position as shown in FIG. 13 in phantom line, and when it is desirous or expedient to attach the retaining frame 16 of eyewear 10 to a relatively thin panel 242 of material or fabric, the leading edge 246 of the panel 242 of material is inserted between the clip 200 and the inner surface 42 of the eyeglass frame when the retainer 40D is installed on or protrudes from the inner surface. The clip 200 is then rotated to the closed position by pushing on the rear tip portion 218 by a finger of the user until the second wire frame portion 212 snap-fits or clips over the ball-catch 234, causing a loop 248 (FIG. 13A) to form in the material or fabric in the space or slot 240 between the rods 214 and 216 of the second frame member. The loop 248 wrapping around the ball-catch 234 effectively increases the size of the ball diameter or cross-dimension, thereby preventing the retainer eyewear from inadvertently slipping off of the panel 242 of material or fabric.

Although relatively thin fabrics have been discussed herein, it will be understood that thicker and/or stiffer fabrics or clothing can be clamped with the retaining member 40D by adjusting the size of the ball-catch 234, the width of the second elongate slot, as well as the diameter of the rods and their elasticity. Suitable materials for the retaining member 40D, including the rods, catch, and base member include plastics, wood, metal, ceramics, composites, combinations thereof, and so on. The rods can be made of spring steel with sufficient resiliency to pass by the ball-catch 234 with elastic deformation yet sufficiently strong to prevent the spring clip 200 from inadvertently releasing from the ball-catch 234. Allowing eyewear frames to be attached securely onto T-shirts, T-shirt pockets, articles of clothing with relatively thin and/or flexible material, such as clothing used for sports, running, cycling, hiking, golfing, fishing, hunting, and so on, allow a wide use of the eyewear with a secure locking mechanism that can readily be accessed when needed for various uses, as previously described.

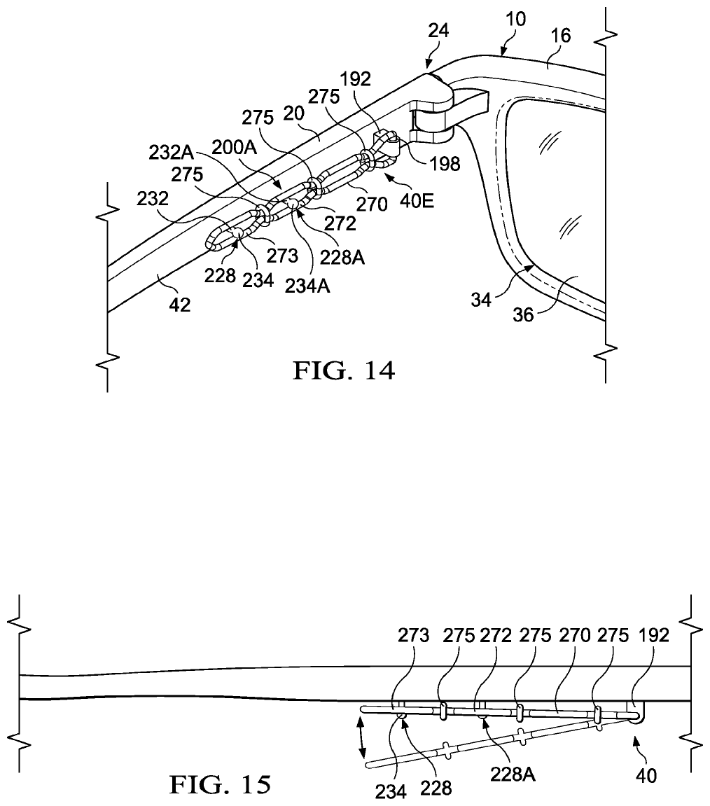

Referring now to FIGS. 14 and 15, a retaining member 40E connected to the temple in accordance with a further embodiment of the invention is illustrated. The retaining member 40E is similar in construction to the retaining member 40D previously described, with the exception that a pair of catch members 228 and 228A replace the single catch member 228 in the previous embodiment, and the elongate spring clip 200A has a first loop portion 270, a second loop portion 272, and a third loop portion 273 with a narrowed section therebetween created by small bands 275. As in the previous embodiment, the loop portions 273 and 272 together with the catch members 228 and 228A, ensure a double clamping operation to hold the eyewear even more secure on the clothing of a user or the like.

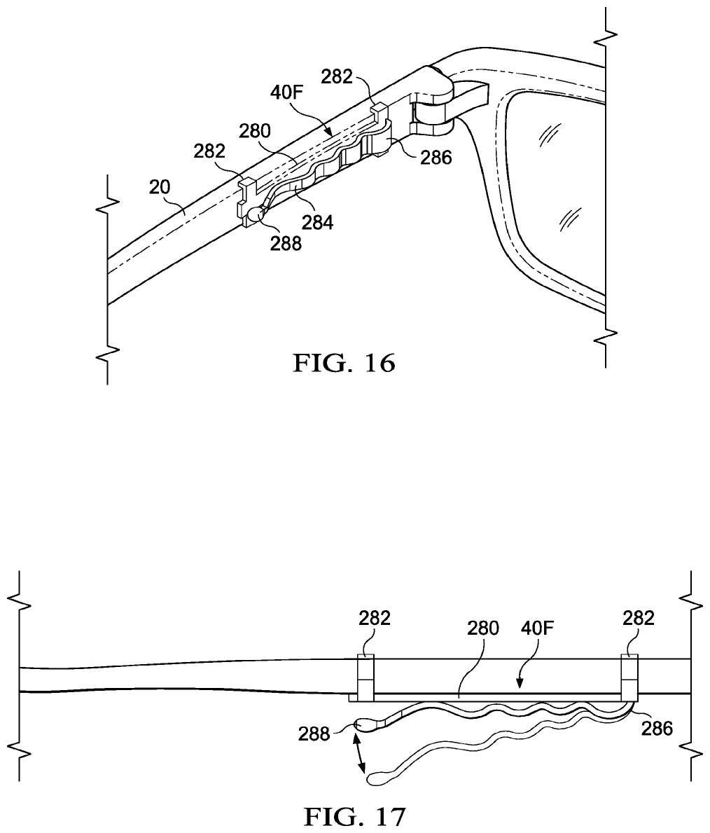

Referring now to FIGS. 16 and 17, a retaining member 40F has a base member 280 with spaced clips 282 that clip on the left temple 20 and/or right temple 26 on the inner and/or outer surface thereof. The retaining member has a wavy locking strip 284 that is somewhat flexible with a hinge 286 at one end and a locking ball 288 at the opposite end thereof. In use, the locking ball 288 is released from the end of the base member 280 and a panel of material is inserted between the wavy locking strip and the locking ball 288. Closure of the locking ball 288 causes the material to be clamped between the base member and the wavy locking strip 284.

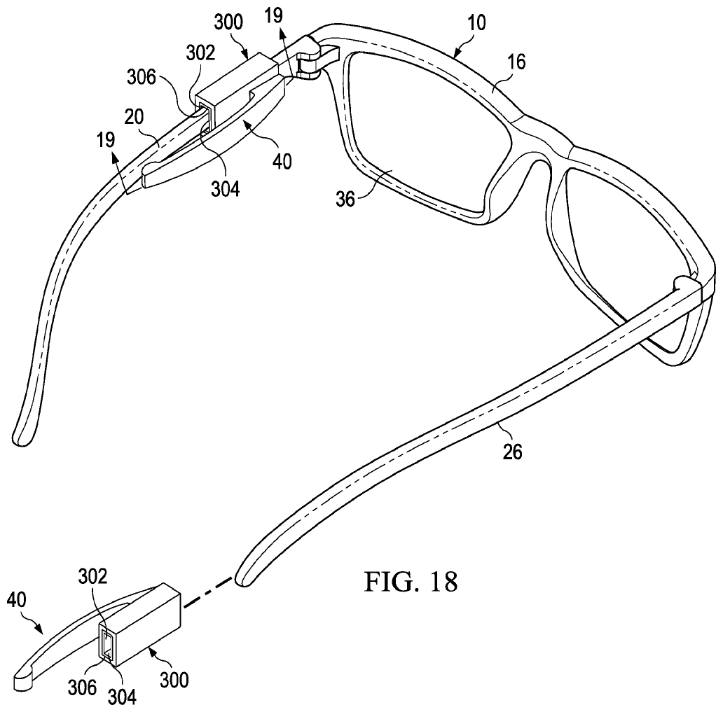

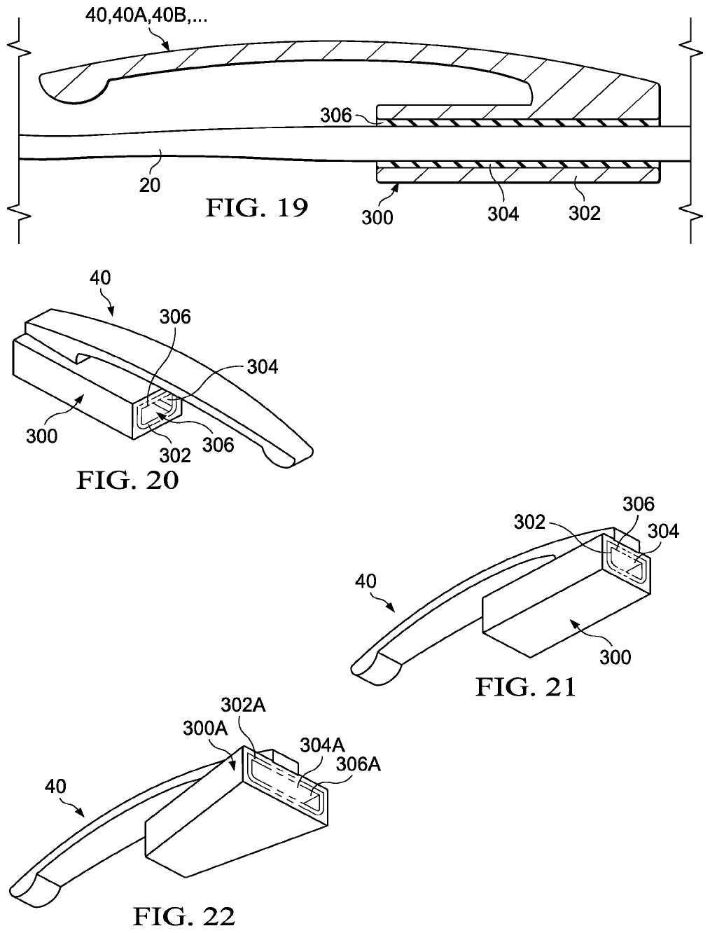

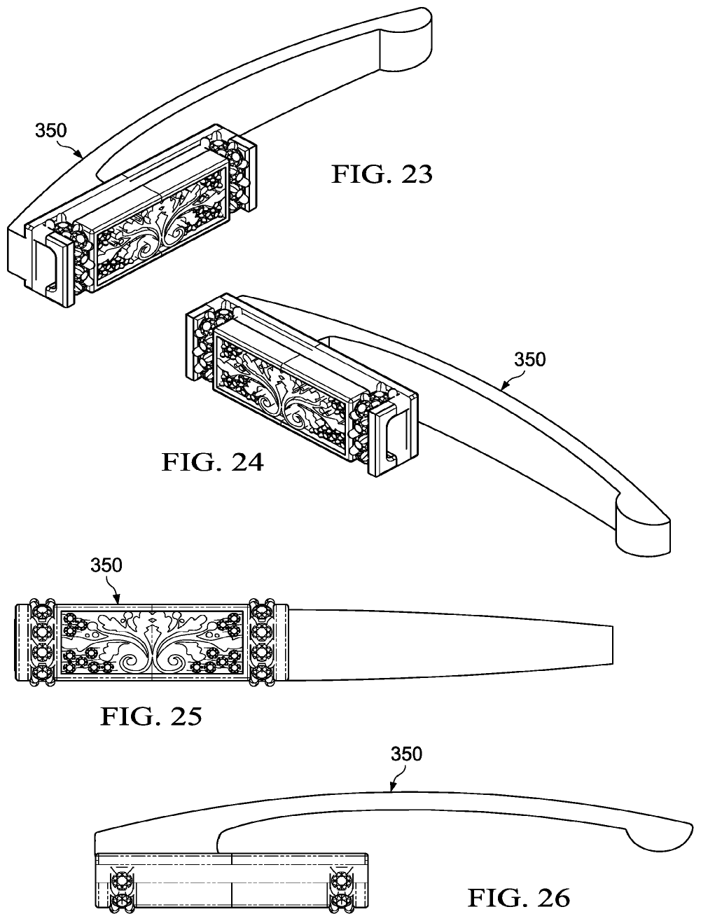

Referring now to FIGS. 18-22, a retaining member 40G in FIGS. 18, 19, 20, and 21 are shown in accordance with a further embodiment of the invention, with FIG. 22 showing a retaining member 40H with a generally triangular-shaped body or sleeve 300A, while FIGS. 18-21 show a rectangular-shaped sleeve 300 having a retaining member 40 thereon, as previously described. The retaining member 40 is preferably integrally formed with the sleeve 300. A rectangular-shaped bore 302 extends through the sleeve 300 that is large enough to fit over a variety of different sized temples, such as left temple 20 and right temple 26 as shown in FIG. 18. Preferably an insert 304 with a smaller bore 306 is installed in the bore 302 for surrounding and engaging the surfaces of the left temple 20 and/or right temple 26. The insert is preferably constructed of a soft silicone, urethane polyurethane, foam rubber, as well as other soft, flexible and/or compressible materials and/or combinations or layers thereof. In accordance with one preferred embodiment of the invention, the insert 304 is constructed of a silicone material having a Shore A hardness in the range of 20 to 70, and more preferably in the range of 40 to 60. In one embodiment, the resiliency of the sleeve has a “gummy-bear” type resiliency that hugs and frictionally holds itself and the sleeve to the temple 20 and/or temple 26. In this manner, the retaining member 40G can be easily and quickly installed on the temples and retained thereon indefinitely, while the retaining member 40 formed integrally thereon, as previously discussed in great detail, has many advantages. It will be understood that the retaining member 40 can be replaced with other retaining members previously described, such as retaining members 40A, 40B, 40C, 40D, and so on, along with each of their unique clamping advantages, can be combined without departing from the spirit and scope of the invention.

In FIG. 22, the sleeve 300A is somewhat triangular in shape and includes the insert 304A received in a bore 302A of the sleeve 300A, and which has a bore 306A for receiving the temple of eyeglasses with unusual shapes. Accordingly, it will be understood that the invention is not limited to particular shapes or styles, but can greatly vary without departing from the spirit and scope of the invention.

Turning now to FIGS. 25-26, the retaining member 300C shows decorative features 350 for example, to enhance the visual or ornamental look of eyewear, while being functional as previously described with respect to retaining members 300, 40, 40A, and so on.

It will be understood that the term “preferably” as used throughout the specification refers to one or more exemplary embodiments of the invention and therefore is not to be interpreted in any limiting sense.

It will be further understood that the term “connect” and its derivatives refer to two or more parts capable of being attached together either directly or indirectly through one or more intermediate members. In addition, terms of orientation and/or position as may be used throughout the specification, such as “inner”, “outer”, “inside”, “outside”, “front”, “rear”, and so on, as well as their derivatives and equivalent terms, denote relative, rather than absolute orientations and/or positions.

It will be appreciated by those skilled in the art that changes could be made to the embodiments described above without departing from the broad inventive concept thereof. It will be understood, therefore, that this invention is not limited to the particular embodiments disclosed, but is intended to cover modifications within the spirit and scope of the present invention as defined by the appended claims.

What is claimed is:

1. A retainer for eyewear comprising:
an eyeglass frame having hinged temple arms; and
a clip associated with at least one of the temple arms to enable the eyeglass assembly to be clipped to a layer of clothing between the clip and the at least one arm without slipping.

2. A retainer according to claim 1, and further comprising a sleeve for slipping over one of the temple arms, and a soft, resilient insert located in the sleeve and having a bore for receiving the one temple arm to thereby resiliently hug the one temple arm while permitting the eyewear to be clipped to an article of clothing.
